(19) United States
(12) Patent Application Publication
(10) Pub. No.: US 2026/0301597 A1
(43) Pub. Date: Oct. 1, 2026

(54) Driving a Motor Vehicle in Virtual Surroundings

(71) Applicant: Bayerische Motoren Werke Aktiengesellschaft, Muenchen (DE)

(72) Inventor: Alexander KUTTNER, Muenchen (DE)

(21) Appl. No.: 18/998,170

(22) PCT Filed: Sep. 19, 2023
(86) PCT No.: PCT/EP2023/075826

§ 371 Date: Jan. 24, 2025

(30) Foreign Application Priority Data
Sep. 26, 2022 (DE) 10 2022 124 717.1

(51) Int. Cl. G09B 9/05; G02B 27/00; G02B 27/01; G06F 3/01; G06V 30/224

(52) U.S. Cl. CPC G09B 9/05; G02B 27/0093; G02B 27/0101; G02B 27/017; G02B 27/0179; G06F 3/011; G06V 30/224; G02B 2027/0138; G02B 2027/0141; G02B 2027/0181; G02B 2027/0187

(57) ABSTRACT

A system comprises a headset, which is configured to be placed on a head of a driver of a motor vehicle, wherein the headset comprises a camera for providing a first view of an interior of the motor vehicle and an optical display for the driver; furthermore a model for providing a view of virtual surroundings of the motor vehicle with respect to a predetermined pose; a device for determining a pose of the head of the driver with respect to the real surroundings of the motor vehicle and a processing device. The processing device is configured to overlay the first view of the interior with a second view of the virtual surroundings with respect to the determined pose and provide same to the driver.

### BACKGROUND AND SUMMARY

A motor vehicle can be controlled by a driver in predetermined surroundings. For example, the motor vehicle can be moved on a test track outside of public road traffic in order to train the driver in the control of the motor vehicle. The test track can comprise devices for bringing the driver dynamically into a predetermined driving situation so that he can learn to manage it better. The driver can thus be trained without subjecting the motor vehicle, the driver, or another person to excessive danger.

A training device on the test track is typically provided so that even if the driver cannot fulfill the task given to him or even loses control over the motor vehicle, preferably no damage occurs. For example, an array of vertical water fountains can be provided, onto which the motor vehicle can drive. If it has reached a predetermined distance, some of the fountains can be turned off so that a gap results through which the driver can steer the motor vehicle. If he should miss the gap, the motor vehicle is hit by a water fountain, but does not impact on a solid object.

Such a training device is complex to configure and operate. Not all driving maneuvers which are possible using the motor vehicle can be trained using a single training device. For example, the mentioned array of water fountains is typically permanently installed and cannot be changed in order to delimit a predetermined curve.

Vice versa, a test track can also be used to check the function of a motor vehicle in a predetermined driving situation. Thus, for example, important aspects of a chassis, a braking system, or a steering system can be practically experienced. It is also true here that even a well-equipped test track only has limited flexibility, and arbitrarily many different tests cannot be carried out on a predetermined, bounded area.

Simulating the behavior of the motor vehicle in a predetermined driving situation has been proposed. A driver can take a seat in a simulator which emulates an interior of the motor vehicle. The exterior of the motor vehicle can be conveyed by a corresponding display, for example, a projector system. The simulator can be inclined to simulate forces acting in the longitudinal or transverse direction on the driver.

In principle, an arbitrary number of different driving situations can be reconstructed with the aid of the simulator. However, the simulator can only convey a real journey to the driver in partial aspects. For example, an acceleration cannot be generated with a strength that goes beyond the acceleration of gravity. Cornering, acceleration, and deceleration in the limit range of the vehicle cannot always be realistically conveyed. The training of the driver in the simulator can therefore be incomplete. The simulator can also only be used to a restricted extent for testing a motor vehicle, since its actual driving behavior is generally not accurately known enough and therefore cannot be correctly simulated under certain circumstances.

One object underlying the present disclosure is to provide a technology for improved realistic driving of a motor vehicle in virtual surroundings.

A system according to the present disclosure comprises a headset configured to be attached to a head of a driver of a motor vehicle. The headset comprises a camera for providing a first view of an interior of the motor vehicle and an optical display for the driver. Furthermore, the system comprises a model for providing a view of virtual surroundings of the motor vehicle with respect to a predetermined pose; a device for determining a pose of the head of the driver with respect to the real surroundings of the motor vehicle, and a processing device. The processing device is configured to superimpose the first view of the interior with a second view of the virtual surroundings with respect to the determined pose and provide them to the driver.

It has been recognized that a realistic driving feeling of a motor vehicle can be conveyed by a real motor vehicle being moved in real surroundings. At the same time, circumstances which characterize a predetermined driving situation can be reconstructed by constructing virtual surroundings.

Mixing views of the real surroundings and the virtual surroundings with one another and presenting them to the driver has been proposed. The driver is to be able to recognize elements in the interior of the motor vehicle unchanged, while a view of elements outside the motor vehicle is replaced by a corresponding view of the virtual surroundings. The driver can move the motor vehicle in the real surroundings in this way, but can be given the impression at the same time of driving through the virtual surroundings.

A convincing and consistent sensory impression can result for the driver due to the mixing of real and virtual contents. He can completely control the motor vehicle and use all systems present on board the motor vehicle. Such systems can comprise, for example, a driver assistance system, an entertainment system, or a comfort system. The virtual surroundings can be controlled such that the driver can experience a predetermined driving situation and learn the control of the motor vehicle in the situation.

For example, a driving technique such as drifting along a predetermined curve can be conveyed harmlessly in this way. A boundary of the curve can exist in the virtual surroundings, while neither a boundary nor an obstacle is present in the real surroundings. If the motor vehicle should leave the virtual curve, no real damage to the motor vehicle can thus occur. In this way, arbitrary curves or sequences of curves can be created in the virtual surroundings, which the driver can really drive through using the motor vehicle. The curves can be provided in a space-saving and delay-free manner with respect to a relatively small real area. The creation or configuration of a real infrastructure in the real surroundings can be omitted. The motor vehicle can be observed better in a predetermined driving situation, which can be brought about by the driver in the virtual surroundings. The motor vehicle can thus be purposefully tested in an improved manner.

The interior of the motor vehicle can be delimited by a window. The superposition is preferably provided such that the virtual surroundings are only visible to the driver in the area of the window. The remaining interior, which can comprise, for example, a vehicle roof lining, a vehicle side rail, a dashboard, a steering wheel, a vehicle seat, an operating element, a side door, a vehicle floor, or a center console, is preferably displayed to the driver from the perspective which his head assumes with respect to the motor vehicle.

Multiple windows can also be provided, which can be handled in the same manner. For example, a windshield can be located in front of the driver, a right or left side window can be located laterally to him, or a sunroof having a further window can be installed in the roof. The window of the motor vehicle is transparent and permits a person on board the motor vehicle who is not wearing a headset to have a view of the real surroundings of the motor vehicle.

A predetermined optical marking can be attached to a window. The processing device can be configured to determine the location of the window in the first view of the interior with respect to the marking.

The optical marking can be easier to recognize automatically than a boundary of the window on a scan of the interior. It is thus possible to prevent a section of the virtual surroundings which the driver sees in the area of the window from having an incorrect size or orientation in relation to the view of the interior. In addition, it is possible to prevent in an improved manner the recognized position of the window from shifting in the first view, for example, during a dynamic maneuver of the motor vehicle. The shifting of the views in relation to one another could otherwise result in an unrealistic impression for the driver, which can result in side effects such as orientation difficulties or nausea.

A shape of the window can be associated with the marking. For example, the marking can comprise a two-dimensional binary optical code, for example, in the form of a QR code, and the shape can be associated with the code. Furthermore, a size or location can also be associated with the marking or the code expressed thereby. The system can be configured for use on different motor vehicles, wherein motor vehicles which comprise windows of different shapes can have different markings. The system can establish in an improved manner based on a recognized marking on board which type of motor vehicle it is located and/or which shape of the window is correct.

The device can comprise a first sensor for determining a pose of the motor vehicle in the real surroundings and a second sensor for determining a pose of the head of the driver in the motor vehicle. The pose of the head of the driver with respect to the real surroundings can thus be determined based on the two poses determined by the sensors, for example, by the processing device. It has been shown that a realistic driving impression can be achieved if the real and the virtual surroundings are matched to one another with high quality. The pose of the head of the driver with respect to the real surroundings can be determined in an improved manner by the two sensors. As a result, the matching of the first and the second view with one another can be achieved with increased precision.

One or more other sensors or information sources on board the motor vehicle are also used to determine the pose of the head of the driver or the pose of the motor vehicle in the virtual surroundings in an improved manner. Such a sensor can be configured to determine a position or an orientation or alignment or both together in the form of a pose.

The device can comprise an absolute positioning device. This can be formed in particular by a receiver for a global navigation satellite system (GNSS). The positioning device can additionally be configured to determine and provide a movement direction and movement speed.

Furthermore, the device can comprise a relative positioning device. This can be formed in particular by an odometer. The odometer can operate based on rotational sensors on wheels of the motor vehicle. A steering angle or a driving speed of the motor vehicle can also be used for the determination of the relative position of the motor vehicle. In one or more embodiments, a camera-based odometer can be provided, in which a position of the motor vehicle is determined with respect to apparent positions of landmarks in the real surroundings of the motor vehicle and known absolute positions associated with the landmarks.

The device can also comprise an acceleration sensor. The acceleration sensor is preferably configured to determine an acceleration along or around a longitudinal axis, a vertical axis, or a transverse axis of the motor vehicle. In particular pitching, rolling, or yawing of the motor vehicle can thus be taken into consideration. The acceleration sensor can also be used to determine shaking of the motor vehicle.

The system can comprise a device for delimiting a position of the motor vehicle to a predetermined area of the real surroundings. Such a technology is known as geofencing. If the motor vehicle crosses over the predetermined area or appears likely to do so, the motor vehicle can be controlled in the longitudinal direction and/or transverse direction in order to counteract this. The area can be selected so that obstacles or harmful objects are arranged outside the area. Safety inside and outside the motor vehicle can thus be ensured in an improved manner.

Another measure for ensuring safety can comprise an additional operating device for the longitudinal or transverse control of the motor vehicle for a further person on board. For example, an additional brake pedal can be provided for a front passenger, who furthermore preferably does not wear a headset. The front passenger can take over the control of the motor vehicle if a predetermined, controllable driving status is departed from.

The system may correctly reflect a display in an interior or exterior mirror. If the interior of the motor vehicle is delimited by a window, on the outside of which a rearview mirror is attached, a further view of the virtual surroundings with respect to the rearview mirror can be determined and superimposed with the first view in such a way that it is visible to the driver in the rearview mirror. In a corresponding manner, a further view of the virtual surroundings with respect to an interior mirror attached in the interior can be determined and superimposed at the corresponding point of the first view. The driver can thus see an area of the virtual surroundings located behind him in an improved and familiar manner.

According to a further aspect, a motor vehicle comprises a system described herein. The motor vehicle can be used to train a driver to guide the motor vehicle or instruct him to bring the motor vehicle into a predetermined driving situation, for example, to study the driving behavior.

A method according to the present disclosure comprises steps of determining a pose of a head of a driver of a motor vehicle with respect to real surroundings of the motor vehicle; determining a first view of an interior of the motor vehicle from the head of the driver; determining a second view of virtual surroundings of the motor vehicle with respect to the determined pose; superimposing the first view of the interior with the second view of the virtual surroundings; and providing the superposition to the driver.

The method can be partially or completely carried out by a system described herein. In particular, at least a part of the method can be carried out by a processing device comprised by the system. This can be embodied electronically in particular and can comprise, for example, a programmable microcomputer or microcontroller. The method can be provided in the form of a computer program product having program code. The computer program product can be stored on a computer-readable data carrier. Features or advantages of the system can be transferred to the method or vice versa.

The virtual surroundings can be adapted depending on a movement of the motor vehicle. The driver can be instructed dynamically, therefore depending on the control originating from him, to control the motor vehicle in a predetermined manner. For example, a notification to change a steering angle can be given or an ideal line on which he is to keep the vehicle can be displayed. Learning a predetermined driving technique, such as drifting, or guiding the motor vehicle in a predetermined driving status can thus take place like a game. The training of the driver or carrying out of a predetermined test of the motor vehicle can thus be accelerated.

In one refinement, the method can be applied on two systems on board two motor vehicles. Even more motor vehicles can also participate in the method, each of which carries a system described herein on board. The motor vehicles are located here in real surroundings, which are separate from one another, however. Virtual surroundings for the systems or motor vehicles are identical to one another here. An interaction between the motor vehicles can thus be reconstructed realistically, but harmlessly, in an improved manner.

The model can comprise an avatar for each of the motor vehicles, wherein the avatar can be updated depending on a movement of the respective motor vehicle. Thus, for example, a collision of the avatars can be determined without a collision of the motor vehicles taking place. Optionally, an optical notification on the avatar of the respective other motor vehicle can be displayed on board a motor vehicle. A driver on board one of the motor vehicles can thus be given the impression of seeing the other motor vehicle in the surroundings of his own motor vehicle. A collision of two motor vehicles can be displayed accordingly on board other motor vehicles.

This refinement can be used to display complex scenarios or have drivers compete against one another with respect to a predetermined task. A driving situation which requires more than one vehicle can be brought about by concerted guidance of the drivers of multiple vehicles.

Aspects of the present disclosure will now be described in more detail with reference to the appended drawings.

### BRIEF DESCRIPTION OF THE DRAWINGS

FIG. 1 illustrates a system on board a motor vehicle;

FIG. 2 illustrates a superposition of views;

FIG. 3 illustrates a driver on board a motor vehicle; and

FIG. 4 illustrates a flow chart of a method.

### DETAILED DESCRIPTION OF THE DRAWINGS

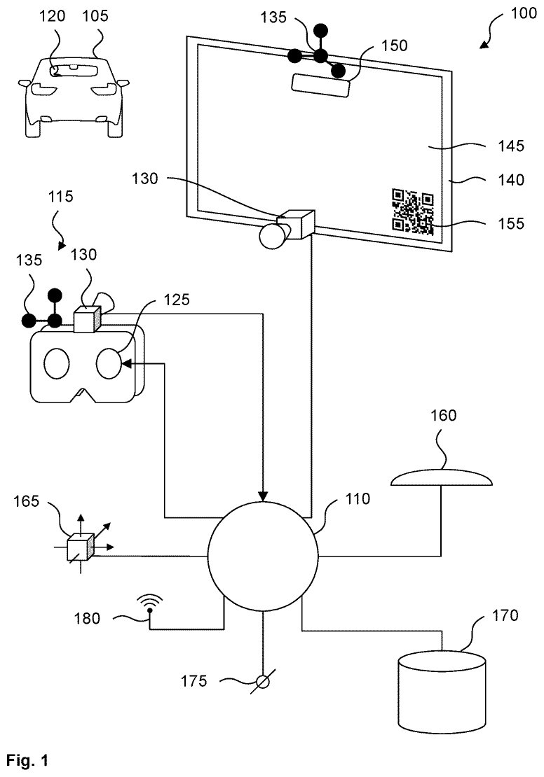

FIG. 1 shows a system 100 on board a motor vehicle 105. The illustrated system 100 comprises a processing device 110 connected to a headset 115. The headset 115 is configured to be attached to the head of a driver 120 of the motor vehicle 105. The driver 120 is located in an interior on board the motor vehicle 105 and can control a longitudinal or transverse movement of the motor vehicle 105. In addition, he can also use further systems or devices on board the motor vehicle 105.

The headset 115 comprises at least one optical display 125 for the driver 120. The headset 115 is preferably embodied in such a way that the display 125 is total for the driver 120, i.e. he can optically perceive the contents which are provided to him by the display 125. In one or more embodiments, one display 125 is provided for each eye of the driver 120. In addition, a camera 130 is attached to the headset 115, which is configured to provide a view of at least the interior of the motor vehicle 105.

Imaging properties of the camera 130 are preferably adapted to optical properties of the visual apparatus of the driver 120, so that a view provided by the camera 130 can be output on a display 125 and an optical impression results for the driver 120 which is as close as possible to that which he would receive without the headset 115. If necessary, the view can be adapted in this sense by the processing device 110. It is to be noted that multiple cameras 130 can also be comprised by the headset 115 or attached thereon.

A marker 135, which can be used as an optical reference pattern, can be attached to the headset 115. The marker 135 is preferably shaped and attached to the headset 115 in such a way that it indicates a position and/or alignment of the headset 115 in an optical manner. For example, a further camera 130 can be attached to a structural element of the motor vehicle 105 and can be configured to optically scan the headset 115. The marker 135 can easily be recognized on the scan, so that a position or alignment of the headset 115 can be determined.

In a corresponding manner, a marker 135 can be attached to a structural element of the motor vehicle 105 and a position or alignment of the headset 115 can be produced with respect to an optical scan of the marker 135 by the camera 130 attached to the headset 115.

Solely by way of example, frame 140 of a window 145, which delimits the interior of the motor vehicle 105, is selected as the structural element in FIG. 1. A marker 135 can be attached, for example, to an upper edge of the frame 140 in the area of an interior mirror 150. The camera 130 is arranged by way of example on the lower edge of the frame 140.

Optionally, an optical marking 155, which is preferably embodied as one-dimensional or two-dimensional, is attached to the window 145. The marking 155 can be binary coded, wherein it comprises light and dark sections, the arrangement and dimensions of which can be automatically processed in order to decrypt a message thus encoded. The message can indicate a geometry of the window 145. The geometry can relate in particular to a size or shape of the window 145. In one or more embodiments, the message 155 comprises a notification of an entry in a data memory, wherein information about the geometry of the window 145 is associated with the entry. The data memory can comprise a plurality of entries and associated geometries.

The system 100 preferably furthermore comprises a receiver 160 for signals of a global navigation satellite system (GNSS). Based on received signals, the receiver 160 can determine a geographical position of the motor vehicle 105 and optionally a movement direction and movement speed of the motor vehicle 105.

An acceleration sensor 165 can be provided in order to determine an acceleration or rotational acceleration of the motor vehicle 105 around one or more spatial axes. The acceleration sensor 165 is preferably configured for determination with respect to a longitudinal axis, a vertical axis, and a transverse axis of the motor vehicle 105. An acceleration along one of the axes (translation) or around one of the axes (rotation) can be determined here. A corresponding acceleration sensor 165 can also be attached to the headset 115 and connected to the processing device 110.

The system 100 furthermore comprises a model 170 configured to reconstruct virtual surroundings. The virtual surroundings are matched to the real surroundings of the motor vehicle 105. For this purpose, a location of the virtual surroundings with respect to the real surroundings is predetermined. If the motor vehicle 105 moves in the real surroundings, it moves in the same manner in the virtual surroundings. If the motor vehicle 105 follows a predetermined trajectory, it assumes a series of poses with respect to each of which views of the virtual surroundings can be determined by the model 170. The series of the provided views corresponds to the impression of a journey along the trajectory through the virtual surroundings.

The course of an underlying surface of the real surroundings of the motor vehicle 105 is preferably re-created in the virtual surroundings. In particular a gradient, a road, an object, or a landmark of the real surroundings can thus be reflected in the virtual surroundings.

An interface 175 is further preferably provided for connection to a device on board the motor vehicle 105. In particular a position, alignment, or movement parameter of the motor vehicle 105 can be acquired via the interface 175. Exemplary devices on board the motor vehicle 105, which can provide such information, comprise an ABS system, an electronic chassis controller, an engine controller for a drive engine, or a navigation system. Optionally, a sensor on board the motor vehicle 105 can also be used for the system 100. For example, an already provided interior camera 130 can be used to scan the headset 115.

Optionally, a wireless communication device 180 is provided, which can be configured to communicate with a central point or another system 100 on board a further motor vehicle 105.

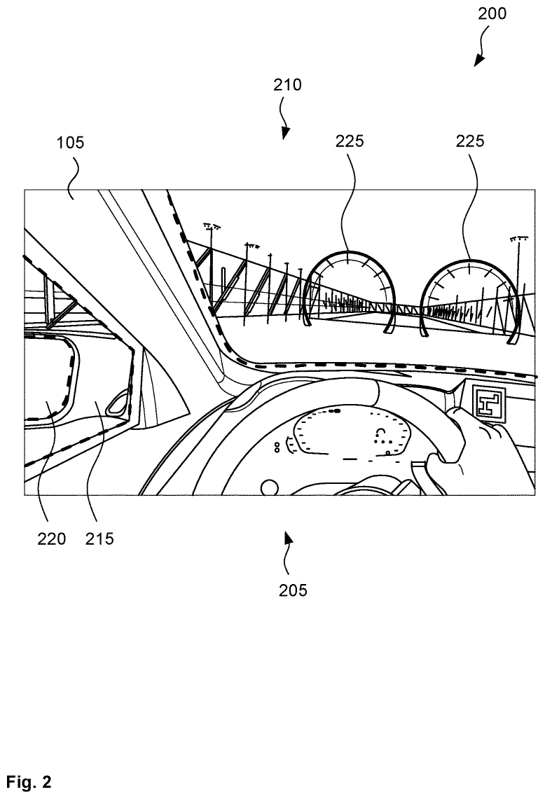

FIG. 2 shows a superposition 200, which can be displayed to a driver 120 on board a motor vehicle 105 upon looking through a headset 115. The superposition 200 comprises sections of a first view 205 and a second view 210. The first view 205 is provided by a camera 130 attached to the headset 115 of the driver 120. The second view 210 is determined with respect to a view of the virtual surroundings of the motor vehicle 105 with respect to a pose of the head of the driver 120.

The first view 205 relates to the interior of the motor vehicle 105 and reflects what the driver 120 could also see without the headset 115 with corresponding head posture. This includes all equipment and functional components of the motor vehicle 105, in particular a steering wheel and a cockpit. The driver 120 also sees himself, as can be seen in FIG. 2 by way of example by the hands of the driver 120 on the steering wheel.

A section of the second view 210 is inserted into the first view 205 where the interior of the motor vehicle 105 is delimited by a window 145. Transition between the first view 205 and the second view 210 is highlighted in FIG. 2 by interrupted lines. These lines are generally not part of the views 205, 210 and cannot be seen by the driver 120.

A windshield and a side window are provided in the illustration of FIG. 2, wherein an exterior mirror 215 can be seen through the side window. Optionally, a section of a third view 220, which is determined by the model 170 in the virtual surroundings with respect to a pose of the exterior mirror 215, can be displayed on a mirror surface of the exterior mirror 215. An opposite exterior mirror or an interior mirror can be handled in a corresponding manner.

For the illustration of a possible mode of operation of the system 100, two gates 225 located adjacent to one another are displayed in the virtual surroundings of the motor vehicle 105 in FIG. 2.

The driver 120 can have the task of driving through the gate 225 which is indicated to him in a specific manner, for example, in a predetermined color, and to avoid the other one, which can be indicated to him in another predetermined color. The colors of the gates 225 can change, for example, according to a predetermined pattern or also randomly. In particular, the colors can be shown not until a late stage depending on a driving speed and a distance of the motor vehicle 105 from the gates 225. A responsiveness and a capability of the driver 120 to drive the motor vehicle 105 in a controlled manner through the correct gate 225, even at high speed, can thus be trained.

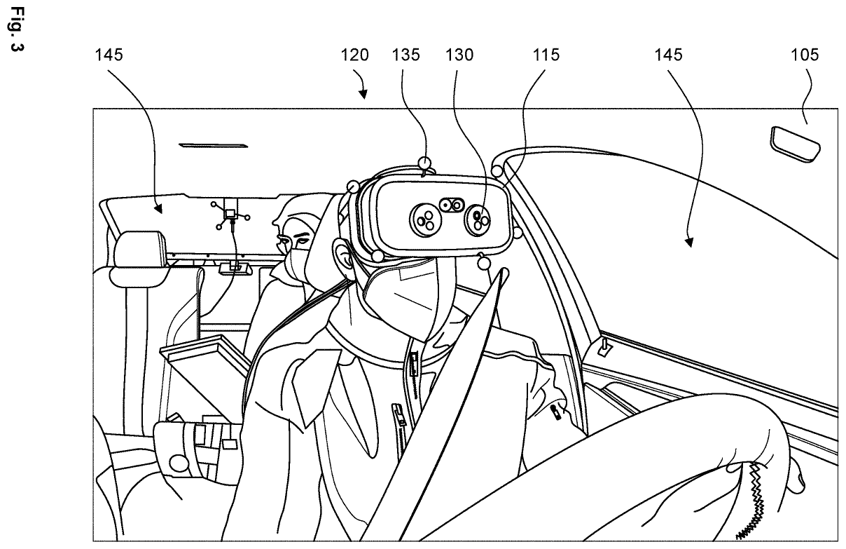

FIG. 3 shows an exemplary view of a driver 120 on board a motor vehicle 105 having a system 100. The headset 115 is attached to the head of the driver 120. The headset 115 is preferably relatively small and light here, so that it does not obstruct the driver 120 and does not interfere with a movement of his head. Two cameras 130 are attached in an area located close in front of the eyes of the driver 120. Elements of a marker 135 are distributed on a frame of the headset 115.

Sections of real surroundings of the motor vehicle 105 can be seen through a side window and a rear window. The driver 120 cannot see the real surroundings and details of the virtual surroundings of the motor vehicle 105 are shown to him in the area of the windows 145 via the headset 115.

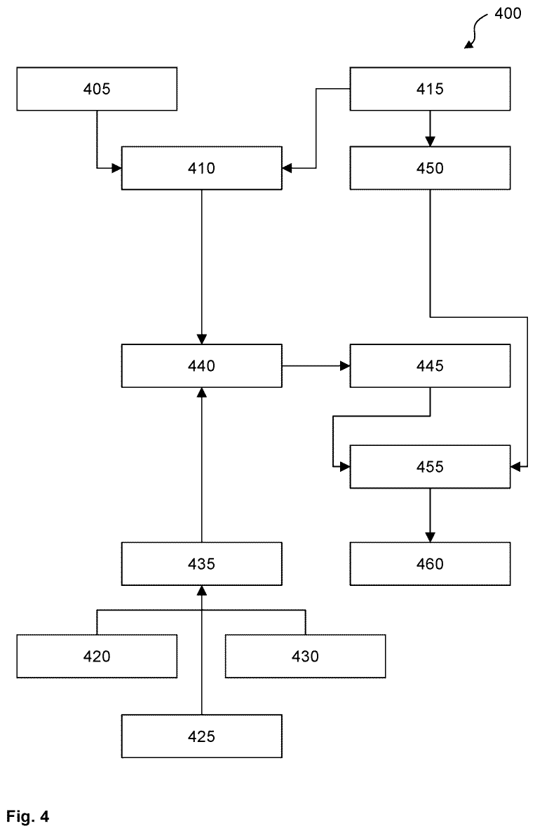

FIG. 4 shows a flow chart of a method 400. The method 400 can in particular be carried out by a system 100.

In a step 405, the headset 115 can be acquired from the vehicle 105. For this purpose, the headset 115 can be scanned by a fixedly attached camera 130.

In a step 410, a pose of the head of the driver 120 in the vehicle 105 can be determined. For this purpose, the pose of the headset 115 can be determined, for example, with respect to the location of the marker 135 on the optical scan.

In a step 415, the interior of the vehicle 105 can be scanned from the headset 115. The camera 130 attached to the headset 115 can be used for this purpose. Optionally, the pose of the head of the driver 120 can also be determined based on this scan. For this purpose, in particular the location of a marker 135, which is fixedly attached to the motor vehicle 105, can be determined in the scan.

To determine the pose of the motor vehicle 105 in the real surroundings, in a step 420, an absolute position of the motor vehicle 105 can be determined. The GNSS receiver 160 or a camera-based position identification unit, which can be connected by the interface 175 to the system 100, can be used for this purpose, for example.

In a step 425, an acceleration of the motor vehicle 105 can be determined. The acceleration can be determined by an acceleration sensor 165 or based on a system on board the motor vehicle 105, for example, a drive or braking system.

A relative position of the motor vehicle 105 can be determined in a step 430. The relative position can be determined in particular with respect to movement or speed information of the motor vehicle 105. For this purpose, in particular signals of an odometer of the motor vehicle 105 can be evaluated, which can be acquired via the interface 175.

The pose of the motor vehicle 105 in the real surroundings can be determined in a step 435 based on information collected in steps 420 to 430.

In a step 440, the pose of the head of the driver 120 in the real surroundings can be determined based on the pose of his head in the motor vehicle 105 and the pose of the motor vehicle 105 in the real surroundings. For optimum results, the pose of the head is to be determined in step 440 with the highest possible accuracy and, in the dynamic case, with the least possible time delay. Intermediate results can be improved based on further information.

In a step 445, a view of the virtual surroundings can be determined based on the determined pose. This view is also referred to herein as the second view.

Based on the scan of the interior in step 415, a view of the interior, which is also referred to herein as the first view, can be determined. In an optional step 450, the location of a window 145 can be determined in the first view. For this purpose, a boundary of the window 145 in the first view can be determined, or geometric information about the shape or dimensions of the window 145 can be applied accordingly.

In a step 455, the first and the second view can be superimposed. Sections of the first view which are located in the area of a window 145 are preferably replaced here by corresponding sections of the second view.

In a step 460, the superposition can be output to the driver 120 via the at least one display 125 of the headset 115.

### LIST OF REFERENCE SIGNS

100 system
105 motor vehicle
110 processing device
115 headset
120 driver
125 display
130 camera
135 marker
140 frame
145 window
150 interior mirror
155 marking
160 GNSS receiver
165 acceleration sensor
170 model
175 interface
180 communication device
200 superposition
205 first view
210 second view
215 exterior mirror
220 third view
225 gate
400 method
405 acquire headset from the vehicle
410 determine pose of the head of the driver in the vehicle
415 scan interior of the vehicle from the headset
420 determine absolute position
425 determine acceleration
430 determine relative position
435 determine pose of the vehicle in the real surroundings
440 determine pose of the head of the driver in the real surroundings
445 determine view of the virtual surroundings
450 determine window
455 superimpose views
460 output to the driver

1-14. (canceled)

15. A system, comprising:
a headset configured to be attached to a head of a driver of a motor vehicle, wherein the headset comprises a camera for providing a first view of an interior of the motor vehicle and an optical display for the driver;
a model for providing a view of virtual surroundings of the motor vehicle with respect to a predetermined pose;
a device for determining a pose of the head of the driver with respect to real surroundings of the motor vehicle; and
a processing device configured to superimpose the first view of the interior with a second view of the virtual surroundings with respect to the determined pose and provide a superposition to the driver.

16. The system according to claim 15, wherein the interior of the motor vehicle is delimited by a window; and wherein the superposition is provided such that the virtual surroundings are visible to the driver in an area of the window.

17. The system according to claim 16, wherein a predetermined optical marking is attached to the window and wherein the processing device is configured to determine a location of the window in the first view of the interior with respect to the marking.

18. The system according to claim 17, wherein a shape of the window is associated with the marking.

19. The system according to claim 15, wherein the device comprises a first sensor for determining a pose of the motor vehicle in the real surroundings and a second sensor for determining a pose of the head of the driver in the motor vehicle.

20. The system according to claim 19, wherein the device comprises an absolute positioning device.

21. The system according to claim 19, wherein the device comprises a relative positioning device.

22. The system according to claim 19, wherein the device comprises an acceleration sensor.

23. The system according to claim 15, further comprising a device for delimiting a position of the motor vehicle to a predetermined area of the real surroundings.

24. The system according to claim 15, wherein the interior of the motor vehicle is delimited by a window, on an outside of which a rearview mirror is attached; wherein a further view of the virtual surroundings with respect to the rearview mirror is determined and superimposed with the first view in such a way that it is visible to the driver in the rearview mirror.

25. A motor vehicle, comprising a system comprising:
a headset configured to be attached to a head of a driver of the motor vehicle, wherein the headset comprises a camera for providing a first view of an interior of the motor vehicle and an optical display for the driver;
a model for providing a view of virtual surroundings of the motor vehicle with respect to a predetermined pose;
a device for determining a pose of the head of the driver with respect to real surroundings of the motor vehicle; and
a processing device configured to superimpose the first view of the interior with a second view of the virtual surroundings with respect to the determined pose and provide a superposition to the driver.

26. The motor vehicle according to claim 25, wherein the interior of the motor vehicle is delimited by a window; wherein the superposition is provided such that the virtual surroundings are visible to the driver in an area of the window.

27. The motor vehicle according to claim 26, wherein a predetermined optical marking is attached to the window and wherein the processing device is configured to determine a location of the window in the first view of the interior with respect to the marking.

28. The motor vehicle according to claim 27, wherein a shape of the window is associated with the marking.

29. The motor vehicle according to claim 25, wherein the device comprises:
a first sensor for determining a pose of the motor vehicle in the real surroundings and a second sensor for determining a pose of the head of the driver in the motor vehicle;
an absolute positioning device;
a relative positioning device; and/or
an acceleration sensor.

30. The motor vehicle according to claim 25, further comprising a device for delimiting a position of the motor vehicle to a predetermined area of the real surroundings.

31. The motor vehicle according to claim 25, wherein the interior of the motor vehicle is delimited by a window, on an outside of which a rearview mirror is attached; wherein a further view of the virtual surroundings with respect to the rearview mirror is determined and superimposed with the first view in such a way that it is visible to the driver in the rearview mirror.

32. A method, comprising:
determining a pose of a head of a driver of a motor vehicle with respect to real surroundings of the motor vehicle;
determining a first view of an interior of the motor vehicle from the head of the driver;
determining a second view of virtual surroundings of the motor vehicle with respect to the determined pose;
superimposing the first view of the interior with the second view of the virtual surroundings; and
providing a superposition to the driver corresponding to the superimposed first view of the interior and the second view of the virtual surroundings.

33. The method according to claim 32, wherein the virtual surroundings are adapted depending on a movement of the motor vehicle.

34. The method according to claim 32, wherein systems on board two motor vehicles are provided in two real surroundings separate from one another, wherein one set of common virtual surroundings is used for the systems.
